(19) United States
(12) Patent Application Publication
(10) Pub. No.: US 2026/0310805 A1
(43) Pub. Date: Oct. 8, 2026

(54) AUTOMATED CONTROL OF ACCESS TO AN ASSET IN INDUSTRIAL POINTCLOUD-BASED REPRESENTATION

(71) Applicant: Siemens Industry Software Inc., Plano, TX (US)

(72) Inventors: Vladislav Murashkin, Livonia, MI (US); Rafael Blumenfeld, Tel Aviv (IL)

(21) Appl. No.: 19/485,012

(22) PCT Filed: May 16, 2023
(86) PCT No.: PCT/IB2023/055016

§ 371 Date: Nov. 17, 2025

(51) Int. Cl. G06F 21/62; G06T 19/00

(52) U.S. Cl. CPC G06F 21/6209; G06T 19/00; G06F 2221/2141; G06T 2210/56

(57) ABSTRACT

Systems and a method for receiving data of an engineering model and data of a pointcloud-based representation of a same given industrial environment. Data on a selection of at least two dimension-sizes of an asset of the engineering model is received; a view access to the asset is to be controlled for at least one user. For the asset, the third dimension-size is received or extrapolated from spatial information. An asset volume whose access is to be controlled is defined, herein referred to as an ACA-volume. A volume corresponding to the ACA-volume is identified within the pointcloud-based representation.

### TECHNICAL FIELD

The present disclosure is directed, in general, to computer-aided design, visualization, and manufacturing (“CAD”) systems, product lifecycle management (“PLM”) systems, product data management (“PDM”) systems, production environment simulation, and similar systems, that manage data for products and other items (collectively, “Product Data Management” systems or PDM systems). More specifically, the disclosure is directed to digital models and digital representations of physical environments.

### BACKGROUND OF THE DISCLOSURE

Three-dimensional (“3D”) digital models and representations of physical industrial environments are used by companies to optimize and manage their design, engineering and manufacturing processes. For instance, usages of digital models and representations of factories and of manufacturing assets can include, but are not limited by, manufacturing process design, manufacturing process simulation, manufacturing process analysis, equipment collision checks, inspection and virtual commissioning.

As used herein the term asset denotes any resource (like e.g. device, machinery, equipment, tool, part, conveyor, wall, fence, table, human, room), zone (like e.g. space, volume, area) and/or any other object or element present in a manufacturing facility, or more generally speaking, in an industrial environment. Therefore, as used herein the asset can be any element, object or volume of the industrial environment. For example, the asset can be a room including several sub-assets.

Industrial environments can be digitally represented by a large variety of digital models and representations. Examples of used digital models and representations of industrial environments include, but are not limited by, two-dimensional (2D) layouts, 3D models in CAD format, cloud of points and panoramic images.

As used herein the term engineering model of an industrial environment denotes a data model for representing an industrial environment which can be structured and which can be enabled to include an Access Control List (“ACL”) model with user access rules for its assets. For example, such an engineering model can comprise only textual logical statements and can be graphically visualized in one, two or three dimensions. In industrial applications, an engineering model or system typically comprises a CAD model/system but in some tooling and engineering disciplines a CAD model may not exist and the 3D model may be generated from various algorithms. Other examples of engineering models may comprise 2D layouts, 2D images, meshed models, structured data models, logical models with spatial information, 3D representation from non-CAD formats such as Collada format.

As used herein the term pointcloud-based representation of an industrial environment denotes a representation with a cloud of points or via a panoramic image associated to a pointcloud. Nowadays, such pointcloud-based representations of a physical object or of an industrial environment are becoming more and more relevant for applications in the industrial world. In fact, 3D scanning devices are increasingly deployed in facilities to generate pointcloud-based representations of industrial facilities e.g. clouds of points and associated synchronized panoramic images.

Due to a large variety of technical use case scenarios, industrial users may make use of multiple different models and representations for representing the same industrial environment and any of its assets.

For example, a given industrial machine may be represented via an engineering model comprising an outline of a 2D floor layout or comprising an element of a 3D CAD model. The same given machine may also be represented with pointcloud-based representations e.g. cloud of points and a corresponding panoramic image resulting from the laser and camera scans.

FIG. 3 schematically illustrates exemplary images from engineering models and from pointcloud-based representations of assets of industrial environments for explanatory purposes.

The first image 301 is an exemplary graphic view of a CAD model of an engineering model EM₁ of an industrial machine.

The second image 302 is an exemplary a graphic view of a 2D floor layout of an engineering model EM₂ of a facility zone.

The third image 303 is an exemplary graphic view of a cloud of points of a pointcloud-based representation PCR₁ of an industrial machine.

The third image 304 is an exemplary graphic view of a panoramic image of a pointcloud-based representation PCR₂ of a facility zone. As used herein the term panoramic image denotes a specific panoramic image of a pointcloud-based representation, which is an image synchronized and aligned with a pointcloud, sometimes also known as “panoramic pointcloud image”. Typically such panoramic image is captured by a scanning camera device in synchronization with a Lidar scanning device, therefore the panoramic image includes associations to a cloud of points or point cloud data. In other words, it comprises location data associated to the corresponding cloud of points. Panoramic images may thus refer to and include panoramic images of physical environments in which point cloud points are correlated to the panoramic image pixels by means of the association between panoramic point cloud image and corresponding synchronized pointcloud data. As such, set of pixels in a given panoramic point cloud image may be mapped to corresponding locations in the physical environment, e.g., through 3D coordinates of a 3D space that maps the physical environment. Panoramic point cloud images may provide a 360° field of view angle along a horizontal direction from a given point in a physical environment. Often, the panoramic image is used as an alternative and graphic representation of a “cloud of point” graphical view.

Nowadays, industrial users are provided with software tools for digitally concealing or redacting selected machinery or facility regions to unauthorized users via access control rules applied to the engineering models of the facility.

Unfortunately, when the same selected machinery or the same selected 3D region of the factory needs to be digitally concealed from the pointcloud-based representation—e.g. from the cloud of points or from the corresponding panoramic image—the task of concealing or redacting becomes complex and error prone. Improved techniques are therefore desirable.

### SUMMARY OF THE DISCLOSURE

Various disclosed embodiments include methods, systems, and computer readable mediums for automatic controlling a user access to an asset of a pointcloud-based representation of an industrial environment. A method includes receiving data of an engineering model and data of a pointcloud-based representation of a same given industrial environment including a plurality of assets. The method includes receiving data on a selection of at least two dimension-sizes of an asset of the engineering model; whereby a view access to the asset is to be controlled for at least one user. The method further includes receiving for the asset, the third dimension-size or extrapolating it from spatial information of said asset. The method further includes defining, based on said three sizes, an asset volume whose access is to be controlled, hereafter called “access controllable asset volume” or ACA-volume. The method further includes identifying within the pointcloud-based representation a volume corresponding to the ACA-volume. The method further includes defining an access control list associated to the pointcloud-based representation, said list comprising at least one access rule for a view access to the identified volume by at least one user. The method further includes receiving a request by a specific user to access a view of the pointcloud-based representation of the industrial environment. The method further includes controlling the specific user's view access by allowing a partial view of the pointcloud-based representation by blocking the view of the identified volume based on the check of specific user's access rules defined in said list.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the descriptions taken in conjunction with the accompanying drawings, wherein like numbers designate like objects, and in which:

FIG. 1 illustrates a block diagram of a data processing system in which an embodiment can be implemented.

FIG. 2 schematically illustrates a flowchart for automatic controlling a user access to an asset of pointcloud-based representation of an industrial environment in accordance with disclosed embodiments.

FIG. 3 schematically illustrates exemplary images from engineering models and from pointcloud-based representations of assets of industrial environments.

FIG. 4 schematically illustrates data inputs and outputs for controlling a view access of an asset in accordance with disclosed embodiments.

FIG. 5 schematically illustrates controlled views of assets for engineering models in accordance with disclosed embodiments.

FIG. 6 schematically illustrates a controlled view of an asset for a panoramic image in accordance with disclosed embodiments.

### DETAILED DESCRIPTION

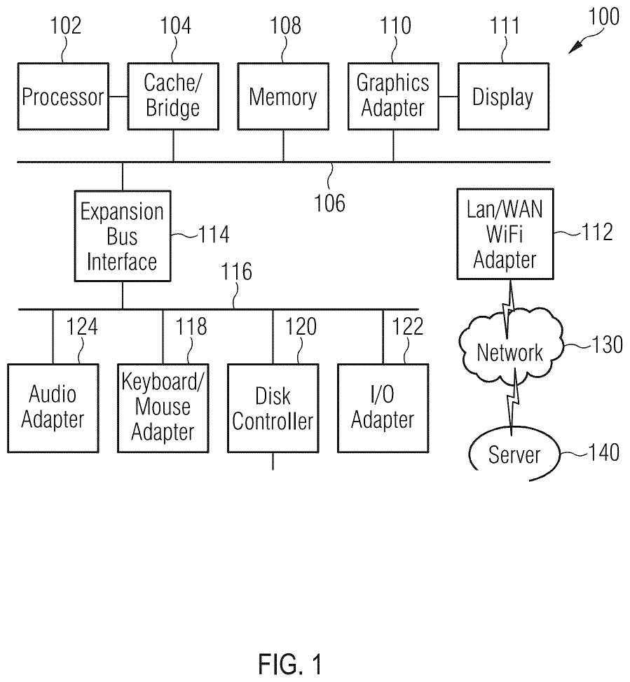

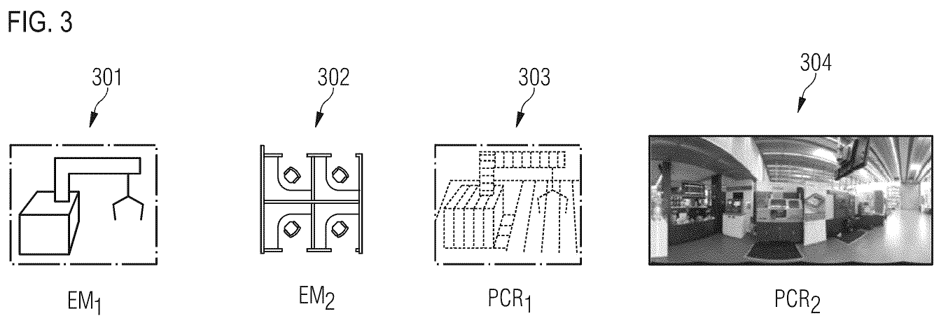

FIGS. 1 through 6, discussed herein, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Previous techniques do not enable to control a user access to a digital asset of an industrial pointcloud-based representation in an automatic manner. For example, previous techniques are error-prone and require too much time and effort.

The embodiments disclosed herein provide numerous technical benefits, including but not limited to the following examples.

Embodiments enable users to control the access to visual information in a spatial region across multiple representations.

Embodiments enable automatic redaction of data across different digital representations of an industrial environment.

Embodiments enable user to automatically align the access control of spatial information of industrial environment representations in engineering models and in pointcloud-based representations such as cloud of points and associated panoramic images.

Embodiments enable to control with Access Control List the visualization of pointcloud-based representations for purposes like security, Intellectual Property protection, business processes and/or users' skills.

Embodiments enable to: formally control the view access to an unstructured/raw data 3D representation of an industrial environment.

Embodiments enable to apply access control rules for certain selected asset locations in the cloud of points or in the panoramic image.

Embodiments enable controlling users access view to equipment pieces and/or to 3D regions of a pointcloud-based representation. Conveniently, the access-controlled visualization may be achieved in real time.

Embodiments provide a software tool for real time redaction of volumes across views of different types of industrial environment representations including unstructured pointcloud-based representations.

Embodiments enable to control for specific users the visualization of specific elements, objects or volumes of pointcloud-based representations like cloud of points and panoramic images.

Embodiments enable to control the access to images to be viewed by regulating the view access to spatial information of the pointcloud-based representation of an industrial environment.

Embodiments enable to render a pointcloud-based representation structured and controllable via an Access Control List.

Embodiments enable industrial professionals to realistically inspect an access controlled view of a digital representation of an industrial environment across multiple representations to evaluate adjustments for validation, optimization, operation management and virtual commissioning purposes. In embodiments, the evaluated adjustments may in turn be performed in the physical industrial environment.

FIG. 1 illustrates a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system 100 illustrated can include a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but are not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A data processing system in accordance with an embodiment of the present disclosure can include an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. May be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

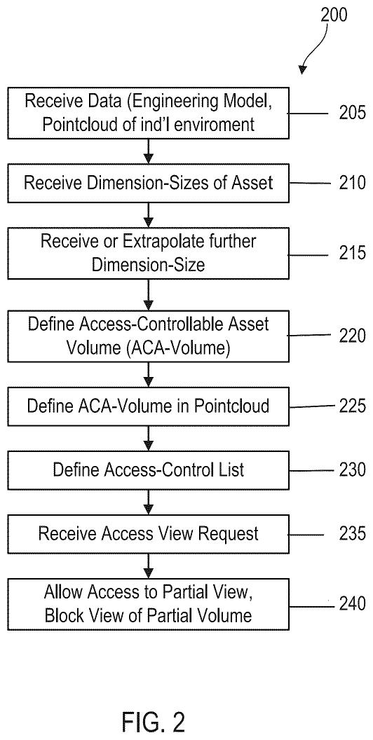

FIG. 2 illustrates a flowchart for automatic controlling a user access to an asset of a pointcloud-based representation of an industrial environment.

At act 205, the system receives data of an engineering model and data of a pointcloud-based representation of a same given industrial environment including a plurality of assets.

At act 210, the system receives data on a selection of at least two dimension-sizes of an asset of the engineering model; whereby a view access to the asset is to be controlled for at least one user. In embodiments, the two dimension-sizes are extrapolated from spatial information of a selected asset. In embodiments, the asset selection data is received from ACL data of the engineering model.

At act 215, for the asset, the third dimension-size is either received or extrapolated from spatial information of the asset.

At act 220, based on said three sizes, an asset volume is defined whose access is to be controlled, herein called “access controllable asset volume” or ACA-volume. In embodiments, the defined asset volume is a minimal prismatic volume of the asset.

At act 225, within the pointcloud-based representation a volume corresponding to the ACA-volume is identified.

At act 230, an access control list associated to the pointcloud-based representation is defined. The list comprises at least one access rule for a view access to the identified volume by at least one user.

At act 235, the system receives a request by a specific user to access a view of the pointcloud-based representation of the industrial environment.

At act 240, the system controls the specific user's view access by allowing a partial view of the pointcloud-based representation by blocking the view of the identified volume based on the check of specific user's access rules defined in the list. In embodiments, a check of the specific user's access rules in the list is done at runtime upon receiving the access view request.

In embodiments, examples of techniques for blocking the view of the identified asset include, and are not limited by, techniques for transparencing the identified asset (e.g. by editing the asset image pixels so as to make the volume empty or transparent); techniques for obfuscating the identified asset (e.g. blending pixels in such way that the dominant colors and areas are present, but objects/elements are not recognizable); techniques for blocking the image; and other techniques for obscuring the visibility of the identified asset.

Embodiments further comprise inspecting the partial view of the pointcloud-based representation for validation, optimization, operation management and virtual commissioning purposes.

In embodiments, the terms “received/receive/receiving”, as used herein, can include retrieving from storage, receiving from another device or process, receiving via an interaction with a user or otherwise.

### Algorithms of Exemplary Embodiments

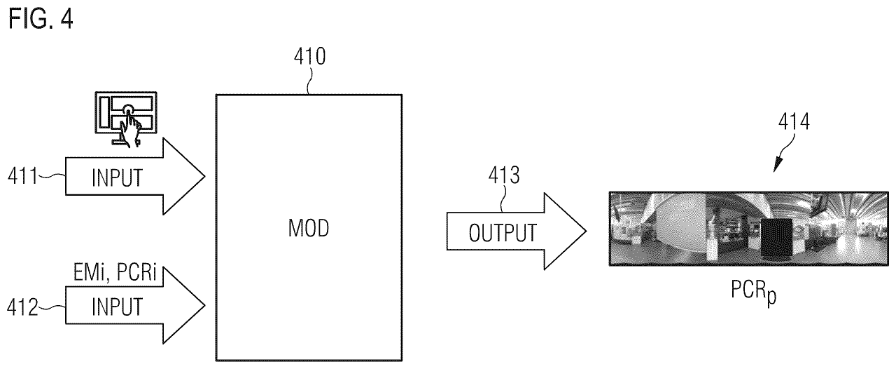

In exemplary embodiments, the main algorithm phases and steps for automatic controlling a user access to an asset of a pointcloud-based representation of an industrial environment are illustrated below with the help of FIGS. 4 to 6.

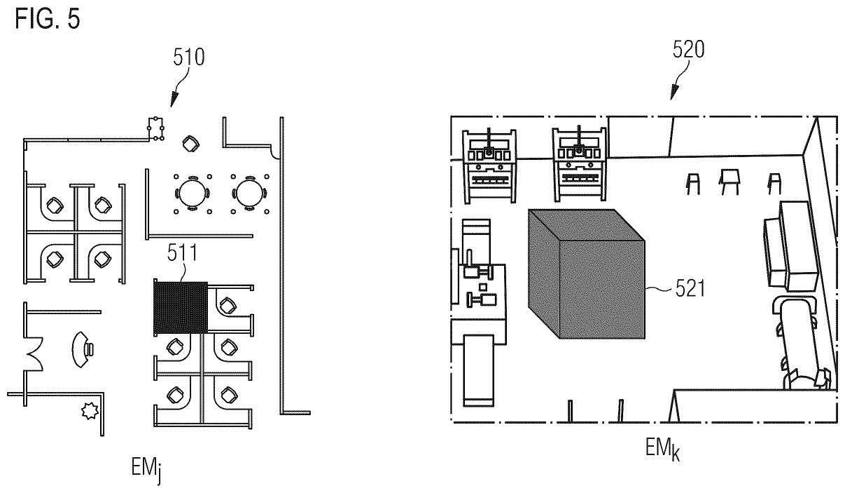

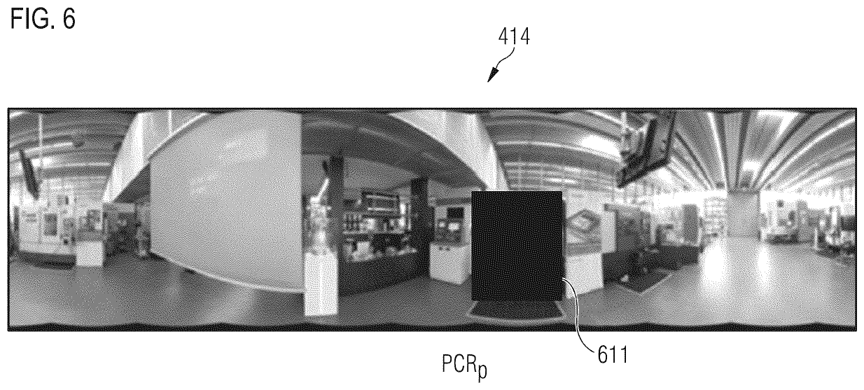

FIG. 4 schematically illustrates data inputs and outputs for controlling a view access of an asset in accordance with disclosed embodiments. FIG. 5 schematically illustrates controlled views of assets for engineering models in accordance with disclosed embodiments. FIG. 6 schematically illustrates a controlled view of an asset for a panoramic image in accordance with disclosed embodiments.

In embodiments, a given user marks 411 on a 2D layout data input 412 of an engineering model 510 an area of a zone or asset 511 that is supposed to be redacted. In other words, the view of this selected asset is to be obscured for another specific user who will request access to display it in a pointcloud-based representation PCRi. For example, width, length can be specified by the given user resulting in a selection of a rectangular box 521. In embodiments, the third dimension—the height—can be specified by the given user, retrieved or extrapolated based on the spatial information on the asset to be redacted. In case, the given user inputs her selection 411 on a 3D engineering model 520 like for example on a CAD system, she can select just a closed body 521. In other embodiments, the given user may provide 411 the asset selection by means of logical descriptors e.g. via spatial coordinates which logically describe an asset in various types of logical engineering model EMᵢ. In summary, in embodiments, the selection of the redactable asset may be given via coordinates, via asset name (equipment, room etc) or via direct selection in one engineering model like for example the CAD model 520 or in the 2D layout 510.

In case the asset volume is a rectangular prism, its 3D coordinates of the rectangular prism or box are stored. In embodiments, when the given user selection is applied on an asset having other shapes, a minimal bounding box or a prismatic volume may be calculated and stored. For example, the bounding box calculation can be done with algorithms for approximating minimal bounding box of a 3D model asset. An asset volume whose access is to be controlled is defined, herein also called ACA-volume. The corresponding ACA-volume is identified in the pointcloud-based representation of the same industrial environment. In embodiments, the coordinates of the identified pointcloud volume are 3D coordinates which can be given as point coordinates for the point of cloud graphics view or pixel coordinates for the associated panoramic image. For the pointcloud-based representation, an Access Control list is defined comprising the pointcloud-based representation coordinates of the identified asset whose view is to be obscured for a certain specific user according to access control and permission rules.

When a specific user requests to view a portion of a panoramic image including the asset 511, 521 whose view is to be blocked, the system checks within the ACL model whether relevant coordinates are present and—if yes—it blocks the view of the identified asset 611 in the panoramic image 414. For each pixel of the image, it is checked whether the coordinates of the identified volume lie in any of the pixels of the panoramic image associated to those points, if yes, the asset view is blocked by rendering black pixels (or any other color) instead of the original pixels. In other embodiments, the view of the asset may be blocked by transparencing it or by obfuscating it.

When a specific user requests to view a portion of a cloud of points (not shown) including the asset to be obscured 511, 521, the system checks within the Access Control list if there are the relevant coordinates and if yes it blocks the view of the identified asset in the cloud of point graphic view (not shown). In embodiments, all points of the cloud of points that lie within the prismatic bounding box are not rendered.

Advantageously, when an unauthorized user requests to display a portion of a pointcloud-based representation with an asset to be concealed, the system via a query takes into account the coordinates of the identified ACA-volume and blocks its view to the unauthorized user for example by coloring in black the corresponding pixels 611 of the panoramic image 414 and the voxels of the cloud of points (not shown).

Advantageously, embodiments enable to automatically redact spatial data across different digital representations and models 411, 412, for example, departing by redacting a spatial region 411 in an engineering model of an industrial environment 412 and receiving as output 413 a pointcloud-based representation view 414 with the spatial information redacted 611 in accordance with access control rules of an Access Control List verified by the access control view module 410.

In embodiments, the ACL model or list contains access control rules for viewing specific assets for certain users for example in a pointcloud-based representation. With embodiments, the visualization of selected volumes in the cloud-based representations are controlled according to the ACL list. In embodiments, a set of assets to be controlled in the pointcloud-representation is identified and thereafter it is set an ACL list for the pointcloud-based representation enabling a view manipulation of the point cloud or of the panoramic image volumes/areas. In embodiments, the pixel mapping and view blocking may advantageously be performed during visualization at runtime.

In embodiments, for the identified asset volumes some ACL properties are defined such as properties defining the visibility access permissions. With embodiments, assets of the engineering models are correlated to corresponding identified asset space of the pointcloud-based representation so as to apply access visualization properties of the ACL of the corresponding ACA-volumes of the engineering models of the same industrial environment. Advantageously, a set of data including the volumes that certain users are not authorized to view in the pointcloud-based representation is automatically created. In other words, with embodiments, the pointcloud-based representation is “upgraded” into a para/proto-model to enable visualization access control for certain unauthorized users.

In embodiments, the input data 411 may be an engineering model-like 2D layout or 3D CAD model-which may be already regulated by an Access Control List. In embodiments, the output data 413 comprise a pointcloud-based representation with an added Access Control List. In embodiments, data and/or metadata of the pointcloud-based representation are associated to access rights of the Access Control List. Advantageously, the coordinates of an asset volume of the pointcloud-based representation are associated to access authorization rights. In embodiments, an abstract vector of cloud of points may be associated to the Access Control List of an engineering model. In embodiments, a file format may conveniently be defined to associate asset volume coordinates to access control rules. In embodiments, in order to visualize on screens pixels describing points of the cloud of points or of the panoramic image, it is checked whether the associated coordinates relate to volumes of assets to be redacted to unauthorized users.

Embodiments enable to calculate the volume of the asset to be concealed at run time on the fly upon receiving a visualization request by a specific user. Advantageously, the calculation is done based upon the credentials of the specific user and it is not necessary to maintain and prepare a priori large pointcloud data for visualizing a pointcloud-based representation for different users having different authorization permissions and roles. Advantageously, in embodiments, no pointcloud data needs to be duplicated or stored somewhere and conveniently the visualization of such data is controlled according to users' roles.

In embodiments, given users are enabled to define access control rules for certain specific users, e.g. blocking for certain unauthorized users the view of a machine or of a space. With embodiments, when receiving a request to view the pointcloud-based representation, the system automatically take those access control authorization permissions into account. Embodiments enable view blocking for any 3D region selection, not only for equipment pieces or other objects. In fact, the asset whose view is to be redacted may be an object for example an equipment piece or it may any spatial region that a given user would like to conceal to certain specific users. Embodiments enable the automation of access control view blocking selected assets across different views of engineering models and pointcloud-based representations of a same industrial environment in real time.

Embodiments enable blanking for certain users without access control permissions the view of asset volumes in engineering models and in pointcloud-based representations of an industrial environment.

Embodiments further comprise simultaneously displaying a partial view of an engineering model representation of the same industrial environment wherein the visibility of the ACA-volume is obscured. Embodiments enable to simultaneously display a plurality of updated views e.g. CAD model views, cloud of point views, panoramic image views where the view of a certain asset is blocked.

Exemplary algorithms may comprise one or more of the following steps:
receiving—as inputs 412—data on a plurality of engineering models EMᵢ and pointcloud-based representations PCRᵢ of a same industrial environment;
receiving—as inputs 411—data on coordinates of a selected asset volume whose view is to be redacted for certain users and/or determining such coordinates from bounding box volume of a selected asset 521 of a CAD model 520;
identifying the coordinates of the asset volume within the pointcloud-based representation;
providing the certain users with an adapted pointcloud-representation view 414 whereby the asset volume view 611 is blocked by a modification on its corresponding pixels/voxels.

In embodiments, the step of identifying the asset volume in the pointcloud-based representation may require a complex evaluation for aligning the asset volume among the different digital representations.

In embodiments, the pointcloud asset volume is identified by calculation of the corresponding pointcloud coordinates via the alignment data between the pointcloud-based representation and the engineering model data. In embodiments, the pointcloud-based representation coordinates comprise the RGB-colors of the points so, during streaming, the visualization of each point which belongs to the asset volume range—with some optional offsets to compensate possible pointcloud errors—is replaced by an RGB-color of black or other selected RGB color—so it can be transparent or any other color.

In embodiments, the engineering model is combined to the pointcloud-based representation by a synchronization to identify the same element. For example, the identification of the asset coordinates in the cloud of points may be done via segmentation of the cloud points and via association of the asset position with the corresponding coordinates of the asset of the CAD model. Examples of algorithms for identifying in a cloud of points the coordinates of a given selected volume include, but are not limited to, by determining the position of a the asset volume of the engineering model in the origin of the cloud of points or in the panoramic image, by synchronizing a same element between a CAD model and a pointcloud-based representation, by mapping techniques, by intersecting techniques, by techniques for aligning the identified minimal prismatic volume from an engineering model to a pointcloud-based representation.

Embodiments enable to automatically transfer the users' permission authorizations of elements and their identities of a CAD model into associated identified location coordinates of a volume of a panoramic image or of a cloud of points. Advantageously, in embodiments, a hidden element of a CAD view is blocked also in a corresponding region of a view of a pointcloud-based representation via access control right check.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being illustrated or described herein. Instead, only so much of a data processing system as is unique to the present disclosure or necessary for an understanding of the present disclosure is illustrated and described. The remainder of the construction and operation of data processing system 100 may conform to any of the various current implementations and practices known in the art.

It is important to note that while the disclosure includes a description in the context of a fully functional system, those skilled in the art will appreciate that at least portions of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims.

1-15. (canceled)

16. A method for automatically controlling, by a data processing system, a user access to an asset of a pointcloud-based representation of an industrial environment, the method comprising the following steps:
a) receiving data of an engineering model and data of a pointcloud-based representation of a same given industrial environment including a plurality of assets;
b) receiving data on a selection of at least two dimension-sizes of an asset of the engineering model, wherein a view access to the asset is to be controlled for at least one user;
c) receiving for the asset a third dimension-size or extrapolating the third dimension-size from spatial information of the asset;
d) based on three sizes, being the at least two dimension-sizes and the third dimension-size, defining an access controllable asset volume (ACA-volume), being an asset volume whose access is to be controlled;
e) identifying within the pointcloud-based representation a volume corresponding to the ACA-volume;
f) defining an access control list associated with the pointcloud-based representation, the access control list comprising at least one access rule for a view access to the identified volume by at least one user;
g) receiving an access view request from a specific user to access a view of the pointcloud-based representation of the industrial environment; and
h) controlling the specific user's view access by allowing a partial view of the pointcloud-based representation by blocking a view of the identified volume based on a check of the specific user's access rules defined in the access control list.

17. The method according to claim 16, wherein the defined asset volume is a minimal prismatic volume of the asset.

18. The method according to claim 16, which comprises performing the check of the specific user's access rules in the access control list at runtime upon receiving the access view request.

19. The method according to claim 16, which comprises blocking the asset view by techniques selected from the group consisting of:
techniques for transparentizing the identified asset;
techniques for obfuscating the identified asset; and
techniques for blocking the identified asset.

20. The method according to claim 16, further comprising inspecting the partial view of the pointcloud-based representation for validation, optimization and virtual commissioning purposes.

21. A data processing system, comprising:
a processor; and
an accessible memory, wherein the data processing system is configured to:
a) receive data of an engineering model and data of a pointcloud-based representation of a given industrial environment which includes a plurality of assets;
b) receive data on a selection of at least two dimension-sizes of an asset of the engineering model; wherein a view access to the asset is to be controlled for at least one user;
c) receive a third dimension-size for the asset or extrapolate the third dimension-size from spatial information of the asset;
d) based on three sizes, being the at least two dimension-sizes and the third dimension-size, defining an access controllable asset volume (ACA-volume), being an asset volume whose access is to be controlled;
e) identify within the pointcloud-based representation a volume corresponding to the ACA-volume;
f) define an access control list associated with the pointcloud-based representation, the access control list comprising at least one access rule for a view access to the identified volume by at least one user;
g) receive a request by a specific user to access a view of the pointcloud-based representation of the industrial environment;
h) control the specific user's view access by allowing a partial view of the pointcloud-based representation by blocking a view of the identified volume based on a check of the specific user's access rules defined in the access control list.

22. The data processing system according to claim 21, wherein the defined asset volume is a minimal prismatic volume of the asset.

23. The data processing system according to claim 21, wherein the check of the specific user's access rules in the access control list is done at runtime upon receiving the access view request.

24. The data processing system according to claim 21, configured to block the asset view by techniques selected from the group consisting of:
techniques for transparentizing the identified asset;
techniques for obfuscating the identified asset; and
techniques for blocking the identified asset.

25. The data processing system according to claim 21, further configured to inspect the partial view of the pointcloud-based representation for validation, optimization and virtual commissioning purposes.

26. A non-transitory computer-readable medium encoded with executable instructions which, when executed, cause one or more data processing systems to:
a) receive data of an engineering model and data of a pointcloud-based representation of a same given industrial environment including a plurality of assets;
b) receive data on a selection of at least two dimension-sizes of an asset of the engineering model; wherein a view access to the asset is to be controlled for at least one user;
c) receive a third dimension-size for the asset or extrapolating the third dimension-size from spatial information of the asset;
d) based on three sizes, being the at least two dimension-sizes and the third dimension-size, defining an access controllable asset volume (ACA-volume), being the asset volume whose access is to be controlled;
e) identify within the pointcloud-based representation a volume corresponding to the ACA-volume;
f) define an access control list associated with the pointcloud-based representation, the access control list comprising at least one access rule for a view access to the identified volume by at least one user;
g) receive a request from a specific user to access a view of the pointcloud-based representation of the industrial environment; and
h) control the specific user's view access by allowing a partial view of the pointcloud-based representation by blocking the view of the identified volume based on a check of the specific user's access rules defined in the access control list.

27. The non-transitory computer-readable medium according to claim 26, wherein the defined asset volume is a minimal prismatic volume of the asset.

28. The non-transitory computer-readable medium according to claim 26, wherein the check of the specific user's access rules in the access control list is done at runtime upon receiving the access view request.

29. The non-transitory computer-readable medium according to claim 26, wherein the one or more data processing systems are caused to block the asset view by techniques selected from the group consisting of:
techniques for transparentizing the identified asset;
techniques for obfuscating the identified asset; and
techniques for blocking the identified asset.

30. The non-transitory computer-readable medium according to claim 26, wherein the one or more data processing systems are caused to inspect the partial view of the pointcloud-based representation for validation, optimization and virtual commissioning purposes.
